(19) United States
(12) Patent Application Publication
(10) Pub. No.: US 2014/0234487 A1
(43) Pub. Date: Aug. 21, 2014

(54) DAIRY BASED COMPOSITIONS WITH LOW LPS

(71) Applicants: Andries Dirk Siemensma, Leeuwarden (NL); Ynte Piet de Vries, Deventer (NL); Anouk Leonie Feitsma, Bathmen (NL); Paula Maria Leandro Garcia, Nijmegen (NL); Albert van der Padt, Apeldoorn (NL)

(72) Inventors: Andries Dirk Siemensma, Leeuwarden (NL); Ynte Piet de Vries, Deventer (NL); Anouk Leonie Feitsma, Bathmen (NL); Paula Maria Leandro Garcia, Nijmegen (NL); Albert van der Padt, Apeldoorn (NL)

(73) Assignee: FRIESLAND BRANDS B.V., Amersfoort (NL)

(21) Appl. No.: 14/131,813

(22) PCT Filed: Jul. 13, 2012
(86) PCT No.: PCT/NL2012/050504

§ 371 Date: Mar. 6, 2014

(30) Foreign Application Priority Data
Jul. 13, 2011 (NL) 2007100

(51) Int. Cl. A23C 9/14; A23C 9/158; A23C 9/152; A23C 9/20

(52) U.S. Cl. CPC A23C 9/14; A23C 9/203; A23C 9/158; A23C 9/1528; A23C 9/1526
USPC 426/61; 426/491; 426/330.2; 426/580; 426/311

(57) ABSTRACT

The present invention is directed to a method to produce a dairy based food composition with low LPS comprising the steps (a) Providing a milk with a storage time of less than 264 hours and either (b1) Treating the milk with a microfilter of poresize of from 0.01-2 μm such that at least a casein rich fraction and a serum protein rich fraction is obtained, or (b2) Treating the milk such that at least 98 wt % of the Gram negative bacteria is removed, and heating the milk wherein at least 98wt % of the Gram negative bacteria is removed to 60-90° C. The methods of the present invention are very suitable to provide a dairy based food composition wherein less than 5100 EU LPS per liter ready to use food composition is present or wherein less than 39 EU LPS per gram dry product is present.

### FIELD OF THE INVENTION

The invention relates to a method of providing milk proteins. Particularly, the invention relates to a method of making a milk protein composition with a low lipopolysaccharide (LPS) concentration. More specifically the invention relates to a method of making milk protein compositions with low LPS concentration for infant and toddler formula.

### BACKGROUND

The epithelial integrity in the gut is of pivotal importance for an optimal epithelial barrier, e.g. in mammals. The outer membrane of Gram negative bacteria, in contrast to Gram positive bacteria, contains lipopolysaccharides (LPS), which are endotoxines. A single bacterial cell contains approximately 3.5×10⁶ LPS molecules. LPS is a complex, negatively charged molecule composed of a distal polysaccharide chain called the O-specific chain, a core polysaccharide and a lipid moiety referred to as lipid A. LPS acts as endotoxin resulting in induction of strong inflammatory responses in animals and human beings and is involved in the development of several diseases, e.g., sepsis. The toxic part of LPS is the lipid A moiety, which consists of two phosphorylated glucosamine residues and at least 6 fatty acids. These two phosphate groups are essential for the bioactivity of LPS. Incorporated in the outer leaflet of the Gram-negative bacterial cell membrane, the LPS molecule is relatively non-toxic as the lipid A moiety is more or less stown away. However, when a dividing or dying bacterium spontaneously releases LPS into the mammalian circulation, it can interact with several proteins such as albumin, lactoferrin, high-density lipoproteins (HDL), low-density lipoprotein (LDL) and bacterial permeability-increasing protein (BPI).

The LPS-binding protein (LBP) is the most important protein in this respect. The LBP-LPS complex binds to CD14 (Cluster of differentiation 14′) after being released from the membrane of the cells of the myeloid lineage (macrophages, monocytes and polymorphonuclear leukocytes). The CD14 require an accessory receptor complex, the toll-like receptor 4/myeloid differentiation-2 complex (TLR4/MD-2) to initiate a cell signal transduction cascade in the cell. This cascade promotes nuclear translocation of NF-KB and transcription of pro-inflammatory cytokines such as Tumor Necrosis Factor alpha (TNFα). TNFα and other pro-inflammatory cytokines induce vascular permeability, enhanced blood flow, and neutrophil recruitment to the LPS source as well as systemic responses such as fever. At high concentrations, LPS becomes toxic by overstimulation of TLR4 signalling, leading to an excessive inflammatory response that results in adverse reactions such as septic shock. An aberrant immune response to LPS or other bacterial antigens (e.g. flagellin or T cell epitopes) has been linked to inflammatory bowel disease (IBD) and necrotizing enterocolitis (NEC). NEC predominantly affects premature infants and is assumed to be caused by an immature immune response to commensal organisms that colonize the gut after birth. Premature infants probably have impaired LPS sensing since they miss an essential molecule from the TLR4-induced signalling pathway and therefore neonates are predisposed to NEC upon microbial colonization of the immature intestine since one of the most abundant sources of LPS encountered by vertebrates is their resident gut microbiota. These gut microbiota do not elicit pathological inflammation in adult hosts. There are also indications that LPS plays an important role in the induction of systemic inflammation. Since newborn babies have a higher permeability of their gut epithelium during the first months or their lives, pathogenic substances have a higher chance to cross the epithelial barrier and induce inflammation in the child.

Raw milk can contain significant numbers of Gram negative bacteria. For health safety reasons, in food, bacteria, including the Gram negative bacteria are killed by pasteurisation and sterilisation techniques. Unfortunately killing the Gram negative bacteria does not result in complete degradation of the membrane of Gram negative bacteria and the LPS molecules stay largely intact and are therefore released into the composition. In addition, during the processing of a food composition, LPS is released from the bacterial wall due to the shearing forces caused by the food processing techniques. LPS is heat stable at 100° C. and can survive during the processing of food products.

Often the proteins in infant food and other dairy based products come from a whey fraction that stems from the cheese making process. The whey fraction contains many nutritional whey proteins such as a-lactalbumin and 6-lactoglobulin. During the process of cheese making, the milk is first often heat treated to kill bacteria including Gram negative bacteria and to inactivate unwanted enzymes. As explained above these treatments will release LPS in the milk. During the cheese making process the LPS may thus end up in the whey fraction. In addition, during the next processing steps of the whey fraction in the making of the infant formula or other dairy based food, contamination of Gram negative bacteria may again occur and therefore additional heat treatments may be carried out. Although the bacteria count may be under control this way, this can lead to an increasing amount of LPS that ends up in the formula. As is explained above, a high LPS load is not desirable in infant formula.

Another method to provide a protein fraction that may be used to produce infant formula or other dairy based food is a method that uses microfiltration. A background reference on providing protein fraction from milk with microfiltration is U.S. Pat. No. 5,169,666. Herein bovine milk is subjected to low temperature ultrafiltration or microfiltration.

Another background reference is EP 1 133 238. Herein a protein composition, derived from whey, is manufactured by subjecting milk that has not been heat-treated, or at most has undergone a moderate heat treatment, to microfiltration at elevated temperature (typically 50° C.).

A further background reference is WO 2008/127104. This concerns a serum protein product suitable as an ingredient for e.g. babyfoods, which is obtained by micro-filtration of bovine milk at a temperature of 10° C.-20° C. utilizing a membrane having a pore size of between 0.3 and 0.5 μm.

The prior art methods including the ones mentioned above may provide protein fractions that are suitable for producing infant formula and other dairy based products, but they are not directed to minimize the LPS content, and thus the LPS content in the protein fractions, and thus in the final dairy product, may be quite high. For instance the LPS is not removed by the microfiltration method and may end up in the permeate fraction.

EP 1 359 924 B1 discloses that lactic acid bacteria and bifidobacteria, particularly those with hydrophobic surface, have the ability to bind endotoxins. The hydrophobic lactic acid bacteria or bifidobacteria should have a percent hydrophobicity (% H) of at least 80% H. As these bacteria grow they may bind up to 95% of the LPS molecules present. However, the LPS molecules are still present in the composition and may thus become detached from the hydrophobic bacteria by e.g. heat treatment or shear forces during the processing of the composition. In addition, if one does not want to add the hydrophobic bacteria to the composition, there is still no satisfiable method to produce a composition with a low level of LPS.

### SUMMARY OF THE INVENTION

It is therefore desirable to have a composition that is microbiologically safe but that also has a low LPS load. The present invention provides a solution.

In a first aspect the present invention is directed to a method to produce a dairy based food composition with low LPS comprising the steps
(a) Providing a milk with a storage time of less than 264 hours
(b) Treating the milk with a microfilter of poresize of from 0.01-2 μm such that at least a casein rich fraction and a serum protein rich fraction is obtained
   In a second aspect the present invention is directed to a method to produce a dairy based food composition with low LPS comprising the steps
(a) Providing a milk with a storage time of less than 264 hours
(b) Treating the milk such that at least 98% of the Gram negative bacteria is removed
(c) Heating the milk wherein at least 98% of the Gram negative bacteria is removed to 60-90° C.
   In a further aspect the present invention is related to a method to produce a dairy based food composition with low LPS comprising the steps
   (a) Providing a milk with a storage time of less than 264 hours
   (b) Treating the milk such that at least 98 wt % of the Gram negative bacteria is removed
(c) Heating the milk wherein at least 98 wt % of the Gram negative bacteria is removed to 60-90° C.
(d) Treating the milk with a microfilter of poresize of from 0.01-2 μm such that at least a casein rich fraction and a serum protein rich fraction is obtained
   In yet another aspect the present invention is directed to a dairy based food composition comprising less than 4000E3 EU LPS per liter ready to use composition or comprises less than 30E3 EU LPS per gram dry product.

### DETAILED DESCRIPTION

The invention is directed to a dairy based composition with low LPS load.

In raw milk Gram negative bacteria are present as well as Gram positive bacteria and enzymes that may spoil the milk. For these reasons the milk is usually pasteurized or sterilized to kill bacteria and inactivate enzymes. During heat treatment and other processes of milk treatment such as creaming and homogenization, the present bacteria can be ruptured. When the Gram negative bacteria are ruptured the LPS is released in the milk. Unfortunately LPS is heat stable and thus after these treatment the milk is loaded with LPS that may still cause harm, especially in vulnerable groups such as infants. The amount of LPS in the milk is dependent on the amount of Gram negative bacteria in the milk. The more Gram negative bacteria in the milk the more LPS will be released in the milk. The older the milk is the more Gram negative bacteria are present in the milk when the milk is not pasteurized or sterilized, as these bacteria will grow and multiply during storage at low temperature.

At the farm the milk that comes from the cow is first stored in a cold tank to keep the milk until the milk is collected and transported to the milk processing factory. In normal circumstances, the milk is collected generally every 2-3 days. The milk of all the cows in these 2-3 days is collected in the cold tank. The milk that is transported to the milk factory is thus a mixture of milk of different ages. It means that the time between the milking of the cow and the arrival of the milk at the factory may be some 3-4 days for the milk that was collected first in the tank and may be only 0.5-1 day for the milk that was last collected.

The storage time of the milk in the present invention is defined as the storage time of the oldest milk, i.e. the milk that is the first collected in the storage tank at the farm. The storage time is the time between the time of milking the cow and the time the milk or products derived therefrom is processed into a dry product or finished concentrate product. The storage time thus comprises the time in the tank on the farm, the transportation time, the storage time in the factory and the processing time in the factory. Normally the storage time may be up to about 2 weeks. For many dairy based products such as infant formulas, part of the protein fraction is often obtained from whey from a cheesemaking process. For such products with a whey fraction the total time between the milking of the cow and the finished product such as a dry infant formula may be up to about 3 weeks. In the present invention the maximum storage time is 264 hours, or 11 days. This is the maximum storage time of the oldest milk. As said before, the milk that arrives at the milk factory is a mixture of milk of different ages, the oldest may have been stored in the tank on the farm for up to 3-4 days while the youngest milk may be only half a day old. Thus the maximum time between the milking of the cow and the milk being incorporated into a dry product or finished concentrate is 264 hours or 11 days. Preferably the storage time is from 250 to 40 hours, more preferably from 220 to 60 hours, even more preferably from 200 to 80 hours, more preferably from 180 to 100 hours, more preferably from 160 to 110 hours, even more preferably from 150 to 130 hours, and most preferably from 145 to 135 hours. Suitable storage times may also be from 10.5 to 1.5 days, more suitably from 10 to 2 days, more suitably from 9.5 to 2.5 days, more suitably from 9 to 3 days, even more suitably from 8.5 to 3.5 days, more suitably from 8 to 4 days, even more suitably from 7.5 to 4.5 days, more suitably from 7 to 5 days, even more suitably from 6.5 to 5.5 days, and most suitably from 6 to 5 days.

The time that it takes from milking the cow and arrival at the milk factory, the arrival time, is also important, and preferably should be as short as possible. Again it should be understood that the arrival time is the time of the oldest milk present in the mixture of milkings. In a preferred embodiment, the arrival time is less than 3 days or less than 70 hours. Preferably the arrival time is less than 2.5 days, more preferably less than 2 days, even more preferably less than 1.5 days, more preferably less than 1 day, and most preferably less than 0.5 day. Suitably the arrival time is less than 60 hours, more preferably less than 50 hours, even more preferably less than 35 hours more preferably less than 25 hours, and most preferably less than 15 hours. As it is important to keep the contamination of the milk of Gram negative bacteria to a minimum, the milking, storing and transfer of the milk, as well as the handling in the milk factory is done in a hygienic or aseptic way.

The milk provided to the process of the invention can, in principle, be from any dairy animal. This is mostly cattle, and particularly cow (adult female cattle), but in addition to cattle, the following animals provide milk used by humans for dairy products: Camels, Donkeys, Goats, Horses, Reindeer, Sheep, Water buffalo, Yaks, and moose. Most preferably, the milk used in the invention is cow's milk.

The microfiltration is generally conducted using a microfilter having a pore size in the range of from 0.01 to 2 micron, preferably from 0.1-1.2 micron, more preferably from 0.2-0.5 micron and most preferably from 0.15 to 0.45 micron. Suitable microfilters are known in the art and include, e.g. spiral wounded polymer or ceramic based systems

For the microfiltration, any conventional apparatus for crossflow microfiltration can be used. Thus, for instance, use can be made of a spiral-wound microfiltration membrane, for instance as described in EP-A-1673975. Preferably, a process system with multiple spiral-wound modules is used. It has been found that it is helpful that in the crossflow microfiltration process measures are taken for reducing the transmembrane pressure across the membrane, in such a manner that the transmembrane pressure is 2.5 bar at a maximum. For that reason, preferably, the transmembrane pressure during microfiltration in a method according to the invention is kept relatively low, that is, 2.5 bar at a maximum. Good results as regards the protein composition of the permeate have for instance been obtained at a maximum transmembrane pressure of 2 bars. The average transmembrane pressure may vary, and is for instance 0.1 to 1.8 bar. In a specific embodiment, the maximum transmembrane pressure is from 0.2 to 1.5 bar, more preferably from 0.3 to 1.2 bar, more preferably from 0.5 to 1 bar and most preferably from 0.6 to 0.8 bar.

Instead of reducing the transmembrane pressure, a different solution may be the use of microfiltration membranes having a gradient in the porosity or thickness of the membrane layer.

In a method according to the invention, standard microfiltration membranes having a pore size of between 0.1 and 1.2 μm may be used. As is known in general, pore size influences the eventual protein composition of the permeate and the retentate. In the light of the present invention, the pore size proves to have an influence inter alia on both the serum protein to casein ratio and the proportion of beta casein in the casein fraction. In an embodiment, use is made of a membrane, for instance a spiral-wound membrane, having a pore size of between 0.2 and 0.5 μm, preferably between 0.15 and 0.45 μm.

The microfiltration steps are conducted starting from milk that comprises non-denatured milk protein and with sufficient microbiological quality. This may refer to raw (untreated) milk, or to milk that has undergone a mild heat treatment, but has not been subjected to a temperature higher than 90° C. The milk may be whole milk or milk which has been skimmed to a greater or lesser degree, raw milk, bactofuged milk or bactofiltered milk or milk pasteurized under mild conditions or reconstituted from powdered milk dried at low temperature. Preferably, non heat-treated, skimmed raw milk is used. If heat-treated, this is done at a temperature below the temperature where Gram negative bacteria are broken down, preferably below 80° C. Suitably the milk and products obtained from the milk during the process are not subjected to a heat treatment at a temperature above 75° C., more preferably not above 70° C., even more preferably not above 65° C., also more preferably not above 60° C., more preferably not above 55° C., most preferably not above 50° C.

The microfiltration step may be performed at a temperature between 0 and 65° C. Preferably the microfiltration is performed at a temperature of between 25 and 65° C. or between 0 and 25° C. More preferably the microfiltration step is performed at a temperature of from 0 to 25° C., more preferably of from 5 to 20° C. and most preferably from 10 to 15° C. In another preferred embodiment, the microfiltration step is performed at a temperature of from 25 to 65° C., more preferably of from 35 to 60° C. and most preferably from 45 to 55° C.

The microfiltration separates the milk into a permeate and a retentate. The retentate is a casein rich fraction and the permeate a serum protein rich fraction. In the casein rich fraction the amount of casein on total protein is more than the amount of casein on total protein in milk that has not been subjected to microfiltration. Preferably, the casein rich fraction comprises 1 wt % more casein on total protein than non-microfiltered milk, more preferably 5 wt % and most preferably 10 wt % more. In the serum protein rich fraction the amount of serum protein on total protein is more than the amount of serum protein on total protein in milk that has not been subjected to microfiltration. Preferably, the serum protein rich fraction comprises 20 wt % more serum on total protein than non-microfiltered milk, more preferably 40 wt % and most preferably 60 wt % more.

In a preferred embodiment the heating step is done at a temperature of between 60-85° C., more preferably between 65 to 80° C., and most preferably between 70 and 75° C. Suitable heating regimes are at 60-65° C. for 1-2 minutes or at a temperature of 70-72° C.′ for 5-30 seconds.

In a preferred embodiment the heating step is done at a temperature of 60-65° C. for 1-10 minutes or at a temperature of 65-85° C. for 5-180 seconds, preferably at a temperature of 65-76° C. for 10-120 seconds, most preferably at a temperature of 66-71° C. for 5 to 180 seconds.

In another aspect the invention is related to a method to produce a dairy based food composition with low LPS comprising the steps
(a) Providing a milk with a storage time of less than 264 hours
(b) Treating the milk such that at least 98% of the Gram negative bacteria is removed
(c) Heating the milk wherein at least 98% of the Gram negative bacteria is removed to 60-90° C.

For microbial safety the milk is treated such that at least 98% of the Gram negative bacteria is removed. Preferably the Gram negative bacteria are removed as intact cells. In a preferred embodiment, the Gram negative bacteria are removed such that the bacterial cells remain intact and that preferably as little as possible and most preferably no additional LPS is released in the treated milk. Bacterial removal techniques are known such as a bacterial filtration with a poresize of 0.5-2.5 micron, centrifugation, or use of antibodies to remove Gram negative bacteria. It is to be understood that there may be other methods that remove Gram negative bacteria. Any method is suitable as long as it removes at least 98% of the Gram negative bacteria and is safe for a food product. With removal is meant that the Gram negative bacteria are taken out of the product, in contrast to being killed but still present in the product, such as e.g. pasteurization and sterilization methods do.

Bacterial filtration with a filter with a pore size of 0.5-2.5 micron removes Gram negative bacteria and spores that are larger than about 0.5-2.5 microns. Suitably the poresize of the bacterial filter is between 0.7 and 2 micron and more preferably between 1 and 1.5 micron. A suitable example of such a bacterial filtration is bactocatch. In a preferred embodiment the filtration to remove Gram negative bacteria and spores is conducted at a temperature of from 0 to 65° C., more preferably of from 35 to 60° C. and most preferably of from 45 to 55° C.

Gram negative bacteria may also be removed by centrifugation. The milk is centrifuged at high speed, e.g. from 5000 rpm to 8000 rpm to remove the Gram negative bacteria. Suitable centrifuge speeds are from 5500 rpm to 7500 rpm, more suitably from 6000 rpm to 7000 rpm. Suitably the Gram negative bacteria are removed by a bactofuge (ex Tetrapack).

Another suitable method to remove Gram negative bacteria is the use of antibodies. Antibodies may be designed to recognize specific Gram negative bacteria or a wide range of Gram negative bacteria. Preferably the antibodies are immobilized to a column or beads so that they can be easily removed.

In a preferred embodiment at least 98.5% of the Gram negative bacteria are removed, more preferably at least 99% of the Gram negative bacteria are removed, and more preferably at least 99.5% of the Gram negative bacteria are removed. Most preferably at least 99.9% or even 100% of the Gram negative bacteria are removed.

After the removal of at least 98% of the Gram negative bacteria, a heating step is performed to inactivate unwanted enzymes and other pathogens that may not have been removed by the bacteria removal step. The heating gives another effect to the microbial safety. Because most of the Gram negative bacteria are removed, the milk may be subjected to a heat treatment up to 90° C., as the disruption of the Gram negative bacteria that are left may release their LPS in the milk, however due to the very low amount of Gram negative bacteria left, if at all, the amount of LPS in the milk is still very low. Preferably, during the process to produce the food product, the milk and product obtained therefrom are not subjected to a heat treatment above 85° C., more preferably not above 80° C. and most preferably not above 70° C. In a preferred embodiment the heating step is done at a temperature of 60-65° C. for 1-10 minutes or at a temperature of 65-85° C. for 5-180 seconds, preferably at a temperature of 65-76° C. for 10-120 seconds, most preferably at a temperature of 66-71° C. for 5 to 180 seconds.

A suitable mild pasteurization technique is at a temperature of 60-65° C. for 1-2 minutes or at a temperature of 70-74° C., preferably 70-72° C.′ for 5-30 seconds.
In a preferred aspect of the invention a method is provided comprising the steps
(a) Providing a milk with a storage time of less than 264 hours
(b) Treating the milk such that at least 98% of the Gram negative bacteria is removed
(c) Heating the milk wherein at least 98% of the Gram negative bacteria is removed to 60-90° C.
(d) Treating the milk with a microfilter of poresize of from 0.01-2 μm such that at least a casein rich fraction and a serum protein rich fraction is obtained
   The bacteria removal step and the microfiltration step may be performed in any order, however it is preferred to have the heating step to follow after the bacteria removal step. In a preferred embodiment, the bacterial removal step is performed before the microfiltration step and most preferably the heating step is performed before the microfiltration step.

Suitably, the microfiltration and/or Gram negative bacteria removal step is performed on milk that has been subjected to a decreaming treatment. Decreaming may be performed with any suitable method known to the skilled person. A suitable method is centrifugation, wherein the heavier proteins and carbohydrates are separated from the less heavy fat particles. Preferably the milk is decreamed to a fat content that is about 70 wt % of the original fat content, more preferably to about 50 wt % of the original fat content, more preferably to about 25 wt % of the fat content and most preferably to about 10 wt % of the original fat content.

In order to make the food composition, the casein rich fraction and/or serum protein rich fraction are used. In a preferred embodiment the serum protein rich fraction is combined with the casein rich fraction or the serum protein rich fraction is combined to another milk product with a storage time of less than 264 hours. Suitably the milk with a storage time of less than 264 hours has been subjected to a treatment wherein at least 98 t % of the Gram negative bacteria have been removed and has been subjected to a heat treatment above temperature 60-90° C. Preferably the serum rich fraction and/or casein rich fraction, or milk is combined to obtain a casein:serum protein ratio of from 0.1 to 2.5 in the dairy based composition, preferably 0.2-2, more preferably 0.3-1 most preferably 0.4-0.7.

In another preferred embodiment fat is added to the composition. The fat may be any fat but is preferably a vegetable fat. Suitable fats comprise sunflower oil, soy oil, safflour oil, rape seed oil, palm oil, palm kernel oil, ricebran oil, olive oil, arachis oil, and coconut oil. Milk fat, butter oil and other animal fat such as lard are also suitable. Fish oil and algae oil are also very suitable. The fat may be a combination of different fats. Suitably the fat is a mixture of vegetable oils and milk fat, cream, butter milk or butter oil. Preferably at least at least 25 wt % of the fat comprises milk fat or butteroil, more preferably at least 40 wt % of the fat comprises milk fat or butter oil.

In addition, other ingredients may be added to the food composition such as vitamins, minerals, polyunsaturated fatty acids, prebiotics, probiotics, protein, antibodies, nucleotides, antioxidants, polar lipids including phospholipids. E.g. it is conventional to add to the food compositions carbohydrates, such as lactose and oligosaccharides, lipids and ingredients such as vitamins, amino acids, minerals, taurine, carnitine, nucleotides and polyamines, and antioxidants such as BHT, ascorbyl palmitate, vitamin E, α- and β-carotene, lutein, zeaxanthin, lycopene and lecithin. In addition, the food composition may be enriched with polyunsaturated fatty acids, such as gamma-linolenic acid, dihomo-gamma-linolenic acid, arachidonic acid, stearidonic acid, eicosapentaenoic acid, docosahexaenoic acid and docosapentaenoic acid. With a view to a proper development of the intestinal flora, probiotics may be added, such as lactobacilli and/or bifidobacteria, as well as prebiotics. A preferred combination of probiotics is for instance Bifidobacterium lactis and/or Bifidobacterium animalis with L. rhamnosis, L. casei, L. paracasei, L. salivarius or L. reuteri. Examples of prebiotics include fuco-, fructo- and/or galacto-oligosaccharides, both short- and long-chain, (fuco)sialyloligosaccharides, branched (oligo)saccharides, sialic acid-rich milk products or derivatives thereof, inulin, carob bean flour, gums, which may or may not be hydrolyzed, fibers, etc.

It should be understood that it may be necessary to concentrate the food product. If such a concentration method is employed it is desirable to use a mild concentration method such that less than 25 wt % of the protein is denatured in the concentrated product. Suitable concentration methods are forward osmosis, reverse osmosis, membrane distillation, freeze concentration, thin-film spinning cone evaporator, and scraped film evaporators. Concentration techniques may be optimised by reduced residence time distribution, and/or improved heat transfer to minimise denaturation.

Dry products have the advantage that they have a longer shelf life due to the reduced level or even lack of water. In addition, dry products are less heavy, and have a smaller volume so that transportation is easier. However, conventional drying techniques will denature a considerable amount of the proteins present. Therefore, the drying is preferably a mild drying step, such that less than 25 wt % of the protein is denatured in the dried product. Suitable drying steps are spray drying, drying in the presence of surface active components, gas injection, drying with super critical CO₂, freeze drying. In the present invention a dry product is a product that contains at least 70 wt % dry matter, preferably at least 75 wt % dry matter, more preferably at least 80 wt % dry matter, more preferably at least 85 wt %, more preferably at least 90 wt %, more preferably at least 95 wt % dry matter and most preferably at least 98 wt % dry matter.

It is to be understood that the food product of the present invention may be any food product that is dairy based and comprises protein, such as yoghurt, desert, dairy drink, cream, crème fraiche, sour cream, ice cream, cheese, dairy spreads. However because of the low LPS load due to the method of the present invention it is especially suitable for a food product for infants and toddlers, medicinal food, food for elderly people and neutraceutical food

The present invention is also directed to dairy based food composition obtainable by a method according the invention.

The method of the present invention provides food compositions that contain very little LPS. As mentioned before, from EP 1 359 924 B1 it is known that lactic acid bacteria and bifidobacteria, particularly those with hydrophobic surface, have the ability to bind endotoxins. The present invention provides methods that reduce the amount of LPS without the addition of lactic acid bacteria and bifidobacteria. Therefore a preferred embodiment comprises a food composition comprising less than 4000E3 EU LPS per liter ready to use composition in a composition more preferably less than 3500E3 EU LPS, preferably less than 3000E3 EU LPS, more preferably les than 2000E3 EU LPS, more preferably less than 1300E3 EU LPS, even more preferably less than 700E3 EU LPS, and most preferably less than 200E3 EU LPS per liter ready to use composition. Suitably for dry product, the food composition comprises less than 30E3 EU LPS per gram dry product, more suitably less than 20E3 EU LPS, more suitably less than 15E3 EU LPS, even more suitably less than 10E3 EU LPS, more suitably less than 7E3 EU LPS, even more preferably less than 5E3 EU LPS and most suitably less than 1.5E3 EU LPS per gram dry product, Preferably the food composition does not comprise lactic acid bacteria and bifidobacteria with a percent hydrophobicity of at least 80% H,

However, the food composition of the present invention may comprise lactic acid bacteria and bifidobacteria and this will even further lower the amount of LPS in the composition. Suitably the food composition of the present invention comprises less than 5100 EU LPS per liter ready to use composition, more preferably less than 5000 EU LPS, preferably less than 4500 EU LPS, more preferably les than 4000 EU LPS, more preferably less than 3000 EU LPS, even more preferably less than 2500 EU LPS, more preferably less than 2000 EU LPS, more preferably less than 1500 EU LPS, more preferably less than 1000 EU LPS, even more preferably less than 750 EU LPS, more preferably less than 500 EU LPS, more preferably less than 250 EU LPS, more preferably less than 150 EU LPS, and most preferably less than 100EU LPS per liter ready to use composition. Suitably for dry product, the food composition comprises less than 39 EU LPS per gram dry product, more suitably less than 35 EU LPS, more suitably less than 30 EU LPS, even more suitably less than 25 EU LPS, more suitably less than 20 EU LPS, more suitably less than 15 EU LPS, even more preferably less than 10 EU LPS, more suitably less than 5 EU LPS, more suitably less than 2 EU LPS and most suitably less than 1 EU LPS per gram dry product. Preferably the food composition comprises lactic acid bacteria and bifidobacteria, preferably with a percent hydrophobicity of at least 80% H,

EU stands for endotoxin units. 10 endotoxin units (EU) are approximately equal to 1 ng of endotoxin. It is to be understood that the E notation as used in the present description stands for “times ten raised to the power of”, thus replacing the X 10 in the Scientific notation, also known as standard form or as exponential notation, with a superscript indicating the power.

Suitably the amount of LPS is measured according to a LAL gel-clot assay or a kinetic chromogenic LAL assay (Gehring et al, Environmental Int 2008; 34:1132-1136). Limulus amebocyte lysate (LAL) is an aqueous extract of blood cells (amoebocytes) from the horseshoe crab, Limulus polyphemus. LAL reacts with bacterial endotoxin or lipopolysaccharide (LPS), which is a membrane component of Gram negative bacteria. LAL contains enzymes that are activated in a series of reactions in the presence of LPS into the Limulus coagulation cascade. This reaction is the basis of the LAL test, which is used for the detection and quantification of bacterial endotoxins. The LAL containing enzymes can split the chromophore, paranitro aniline (pNA), from the chromogenic substrate, producing a yellow color in the kinetic chromogenic LAL assay.

However, LPS enbedded in lipid complexes such as phospholipids in milk derived from milkfat globules, or bound to lactic acid bacteria and bifidobacteria mask the Lipid A moiety from the LPS-binding protein (LPB) and therefore escape detection. Therefore, in such cases the amount of LPS present in the food composition can be detected by combining an aqueous suspension of the lipid complexes with a suitable detergent such as Lubrol-PX™ as described in U.S. Pat. No. 6,015,716.

The method according to the invention yields a casein rich fraction and a serum protein rich fraction. Preferably the casein rich fraction comprises more than 81 wt % casein on total protein, more preferably more than 85 wt % casein on total protein, even more preferably more than 90 wt % of casein on total protein, and most preferably more than 95 wt % of casein on total protein.

Also preferred is a serum protein rich fraction comprising more than 20 wt % serum protein on total protein, more preferably more than 30 wt % serum protein on total protein, even more preferably more than 40 wt % serum protein on total protein, more preferably more than 45 wt % serum protein on total protein, more preferably more than 50 wt % serum protein on total protein, even more preferably more than 55 wt % serum protein on total protein, and most preferably more than 60 wt % serum protein on total protein.

In another aspect, the present invention is directed to a dairy based food composition wherein the ratio of casein:serum protein is 0.1-4.0. Preferably the composition according to the present invention comprises 1 to 40 wt % protein for a ready to use product, and 10 to 80 wt % protein in a dry product, more preferably 20 to 30 wt % of protein for a ready use product, or 20 to 60 wt % of a dry product, most preferably 3 to 25 wt % protein for a ready to use product, or 30 to 50 wt % for a dry product. For infant forumulas suitably the ratio of casein:serum protein is from 0.1 to 4, preferably 0.2-2.5, more preferably 0.3-1 most preferably 0.4-0.7. For medical nutrition or nutrition for elderly a suitable ratio of casein:serum protein is from 3-15, more preferably from 4-12, more preferably from 5-11, even more preferably from 6-10, and most preferably from 7-9.

The dairy based food composition may also comprise fat in an amount of between 0.5 and 15 wt % fat for a ready to use product and 2 to 40 wt % fat in a dry product, more preferably between 1 and 8 wt % fat for a ready to use product or 3 to 30 wt % in a dry product, most preferably 2 to 5 wt % fat in a ready to use product or 5 to 20 wt % in a dry product. The fat may be any fat but is preferably a vegetable fat. Suitable fats comprise sunflower oil, soy oil, safflour oil, rape seed oil, palm oil, palm kernel oil, ricebran oil, olive oil, arachis oil, and coconut oil. Milk fat, cream, butter milk or butter oil and other animal fat such as lard are also suitable. Fish oil and algae oil are also very suitable. The fat may be a combination of different fats. Suitably the fat is a mixture of vegetable oils and butter oil. Preferably at least 25 wt % of the fat comprises butteroil, more preferably at least 40 wt % of the fat comprises butter oil.

In a preferred embodiment the composition according to the invention comprises an amount of beta-casein of from 2 to 4.5 g/L of a ready to use product, preferably from 2.5 to 4 g/L ready to use product and most preferably from 3 to 3.5 g/L ready to use product. Suitably a dry product contains 10-50 mg beta-casein, more suitably 15-40 mg beta casein and most preferably from 20-30 mg beta casein per gram dry product.

In another preferred embodiment the composition according to the invention comprises an amount of alpha lactalbumin from 2 to 4.5 g/L of a ready to use product, preferably from 2.5 to 4 g/L ready to use product and most preferably from 3 to 3.5 g/L ready to use product. Suitably a dry product contains 10-50 mg alpha lactalbumin, more suitably 15-40 mg alpha lactalbumin and most preferably from 20-30 mg alpha lactalbumin per gram dry product.

In another preferred embodiment, the composition according to the invention comprises less than 2 g/L alpha casein in a ready to use product, more preferably les than 1 g/L, even more preferably less than 100 mg/L and most preferably less than 10 mg/L in a ready to use product. Even less than 1 mg/L alpha casein in a ready to use product is very suitable. In a dry product, preferably less than 15 mg alpha casein per gram dry product is present, more preferably less than 1 mg alpha casein per gram dry product is present, more preferably less than 500 mcg/g and most preferably less than 100 mcg/g alpha casein in a dry product.

In another preferred embodiment, the composition according to the invention comprises less than 2 g/L beta lactoglogulin in a ready to use product, more preferably les than 1 g/L, even more preferably less than 100 mg/L and most preferably less than 10 mg/L in a ready to use product. Even less than 1 mg/L beta lactoglogulin in a ready to use product is very suitable. In a dry product, preferably less than 15 mg beta lactoglogulin per gram dry product is present, more preferably less than 1 mg beta lactoglogulin per gram dry product is present, more preferably less than 500 mcg/g and most preferably less than 100 mcg/g beta lactoglogulin in a dry product.

Infant (baby) formula is generally for use, in addition to or in lieu of human breast milk, with infants up to 18 months old. Toddler formula generally refers to follow-on formula for children of 18-48 months. Obviously, it is not excluded in accordance with the invention to use the milk proteins and milk protein compositions obtained, also for other purposes such as enteral food, medical nutrition for children and for the elderly.

It will be understood that any nutritional compositions, such as infant or toddler formula, provided in accordance with the invention, may comprise any further conventional ingredients. E.g. it is conventional to add to baby and infant food and therapeutic compositions carbohydrates, such as lactose and oligosaccharides, lipids and ingredients such as vitamins, amino acids, minerals, taurine, carnitine, nucleotides and polyamines, and antioxidants such as BHT, ascorbyl palmitate, vitamin E, α- and β-carotene, lutein, zeaxanthin, lycopene and lecithin. The lipids are mostly of vegetable origin. In addition, the food or the therapeutic composition may be enriched with polyunsaturated fatty acids, such as gamma-linolenic acid, dihomo-gamma-linolenic acid, arachidonic acid, stearidonic acid, eicosapentaenoic acid, docosahexaenoic acid and docosapentaenoic acid. With a view to a proper development of the intestinal flora, probiotics may be added, such as lactobacilli and/or bifidobacteria, as well as prebiotics. A preferred combination of probiotics is for instance Bifidobacterium lactis and/or Bifidobacterium animalis with L. rhamnosis, L. casei, L. paracasei, L. salivarius or L. reuteri. Examples of prebiotics include fuco-, fructo- and/or galacto-oligosaccharides, both short- and long-chain, (fuco)sialyloligosaccharides, branched (oligo)saccharides, sialic acid-rich milk products or derivatives thereof, inulin, carob bean flour, gums, which may or may not be hydrolyzed, fibers, etc.

The present invention is also directed to the use of a casein rich fraction and a serum protein rich fraction according to the invention to produce a food composition, preferably an infant formula. It is also directed to the use of a serum rich fraction as claimed in claim 24 and a milk wherein at least 98% of the gram negative bacteria are removed and which has been subjected to a heat treatment at a temperature between 60 and 90° C. and/or a milk protein concentrate wherein at least 98% of the gram negative bacteria are removed and which has been subjected to a heat treatment between temperature 60-90° C., to produce a food composition, preferably an infant formula.

Preferably the use of the serum rich fraction and/or casein rich fraction to produce a food composition is wherein the ratio of casein:serum protein is from 0.1-2.5 or from is from 3-15. For infant formulas suitably the ratio of casein:serum protein is from 0.1 to 2.5, preferably 0.2-2, more preferably 0.3-1 most preferably 0.4-0.7. For medical nutrition or nutrition for elderly a suitable ratio of casein:serum protein is from 3-15, more preferably from 4-12, more preferably from 5-11, even more preferably from 6-10, and most preferably from 7-9.

The invention is illustrated in the following, non-limiting examples.

### Example 1

### Preparation of Low LPS/Endotoxin Milk Protein Products with Microfiltration

Raw milk with a storage time of 72 hours is centrifuged (temp: 50-55° C.) in order to separate the cream and to obtain the skimmed milk. In the next step milk is filtered on a ceramic microfilter (poresize 1.5 μm, temp 50-55° C.) and then subsequently pasteurized (72.5° C., 20 s) and cooled down to 6° C. and then stored in a tank at 6° C. The max storage time in this tank is 24 hours.

The incoming skimmed milk and the resulting microfiltrated milk is sampled for determination of total microbial counts (CFU/ml at 30° C.) and endotoxin (EU/g DM). The results are shown in Table 1.

TABLE 1

| | Endotoxin | CFU/ml |
|---|---|---|
| | (EU/g DM) | (30° C.) |
| Skimmed milk | 115 ± 10 | ~9500 |
| Skimmed milk | 74 ± 8 | ~45 |
| (microfiltrated) | | |

The microfiltrated skimmed milk (storage time 108 hours) is stored in a tank at a temperature of 6° C. In the following step, milk is microfiltrated with a spiralwound membrane with a poresize of 0.15 μm (DSS). Filtration is carried out at a temperature of 10-12° C. The transmembrane pressure is max 1.8 bar, preferably 1.3 bar. The preset volume reduction factor was in this example 3.3. In this setting casein micelles are retained in the concentrate, while the majority of the serum proteins will pass the filter in the filtrate.

The obtained casein concentrate is stored in a tank at <6° C. The storage time was 150 h.

| | Endotoxin | CFU/ml |
|---|---|---|
| | (EU/g DM) | (30° C.) |
| Milk casein concentrate | 108 ± 13 | 30 |

The obtained permeate with serum proteins is collected in a tank and then concentrated on an ultrafilter system (spiralwound membrane, cut off 10 kD) at a temperature of 10-12° C. Concentration is carried out until the protein content of the retentate has reached a value of 14-15%. The obtained serumprotein concentrate is stored in a tank at 6° C. The storage time was 150 h.

| | Endotoxin | CFU/ml |
|---|---|---|
| | (EU/g DM) | (30° C.) |
| Serum protein concentrate | 24 ± 3 | 2 |

### Example 2

### Infant Formula Compositions with Low LPS Content

In Table 2, an example is given of an infant formula composition.

TABLE 2

| Component | | Per 100 g |
|---|---|---|
| Proteins | g | 10.6 |
| Serum or whey protein | g | 6.4 |
| Casein | g | 4.2 |
| Fat | g | 27 |
| Linoleic acid | g | 3.4 |
| A-Linolenic acid | g | 0.48 |
| DHA | mg | 53 |
| AA | mg | 53 |
| Carbohydrates | g | 55 |
| Lactose | g | 53 |
| Maltodextrin | g | 2 |
| Dietary Fiber | g | 1.9 |
| Galacto-oligosaccharides | g | 1.9 |
| Minerals, vitamins, | g | 1.9 |
| nucleotides | | |

The infant formula compositions are prepared by using either the serum protein concentrate or the milk casein concentrate or both, which are obtained according to Example 1, as main protein source. These can be combined with (minor amounts of) conventional protein sources, such as milk powder and/or demineralized whey protein powder.

1. Method to produce a dairy based food composition with low LPS concentration comprising the steps
(a) Providing a milk with a storage time of less than 264 hours
(b) Treating the milk with a microfilter of poresize of from 0.01-2 μm such that at least a casein rich fraction and a serum protein rich fraction is obtained.

2. Method according to claim 1 wherein a heating step is included.

3. Method to produce a dairy based food composition with low LPS comprising the steps
(a) Providing a milk with a storage time of less than 264 hours
(b) Treating the milk such that at least 98 wt % of the Gram negative bacteria is removed
(c) Heating the milk wherein at least 98 wt % of the Gram negative bacteria is removed to 60-90° C.

4. Method according to claim 1 additionally comprising the steps
(c) Treating the milk such that at least 98 wt % of the Gram negative bacteria is removed
(d) Heating the milk wherein at least 98 wt % of the Gram negative bacteria is removed to 60-90° C.

5. Method according to claim 3 wherein the treatment to remove at least 98 wt % of the bacteria is selected from the group consisting of
Bacterial filtration with a poresize of 0.5-2.5 micron, preferably at a temperature of from 25 to 65° C.;
Centrifugation;
Use of antibody to remove Gram negative bacteria.

6. Method according to claim 1 wherein during the process to produce the dairy based food composition the milk and product obtained therefrom are not subjected to a heat treatment above 90° C.

7. Method according to claim 1 wherein the microfiltration is performed at a temperature of 0-65° C.

8. Method according to claim 1 wherein the poresize of the microfiltration is from 0.05-1.2 micron more preferably from 0.1 to 0.8 micron and most preferably from 0.15 to 0.5 micron.

9. Method according to claim 1 wherein the transmembrane pressure during microfiltration is less than 2.5 bar.

10. Method according to claim 1 wherein the microfiltration is performed at a temperature of 25-65° C., or 0-25° C.

11. Method according to claim 2 wherein the milk is heated at a temperature of 60-65° C. for 1-10 minutes or at a temperature of 65-85° C. for 5-180 seconds, preferably at a temperature of 65-76° C. for 10-120 seconds, most preferably 66-71° C. for 5 to 180 seconds.

11. Method according to claim 1 wherein the storage time of milk is from 200 to 80 hours.

12. Method according to claim 1 comprising the steps
(a) Providing a milk with a storage time of less than 264 hours
(b) Treating the milk such that at least 98 wt % of the Gram negative bacteria is removed
(c) Heating the milk wherein at least 98 wt % of the Gram negative bacteria is removed to 60-90° C.

13. Method according to claim 1 wherein the milk is subjected to a decreaming treatment before the microfiltration step and/or removal step of the Gram negative bacteria.

14. Method according to claim 1 wherein the serum protein rich fraction is combined with the casein rich fraction or with a milk protein product with a storage time of less than 264 hours to obtain a casein:serum protein ratio of from 0.1 to 4.0 in the dairy based composition, preferably 0.2-2, more preferably 0.3-1 most preferably 0.4-0.7.

15. Method according to claim 1 wherein a fat is added to the composition.

16. Method according to claim 15 wherein at least 25 wt % of the fat comprises butteroil.

17. Method according to claim 1 wherein ingredients selected from the group consisting of vitamins, minerals, polyunsaturated fatty acids, prebiotics, probiotics, protein, antibodies, nucleotides, antioxidants and phospholipids are added to the composition.

18. Method according to claim 1 wherein a drying step is present.

19. Method according to claim 1 wherein the food composition is selected from the group consisting of infant formula, medicinal food, neutraceutical food composition, yoghurt, drink, spread, or cream.

20. Method according to claim 1 wherein the milk is a bovine milk, preferably cow's milk.

21. Dairy based food composition obtainable by a method according to claim 1.

22. Dairy based food composition wherein less than 4000E3 EU LPS per liter ready to use food composition is present or wherein less than 30E3 EU LPS per gram dry product is present.

23. Dairy based food composition according to claim 22 wherein less than 5100 EU LPS per liter ready to use food composition is present or wherein less than 39 EU LPS per gram dry product is present.

24. Dairy based food composition according to claim 21 comprising lactic acid bacteria and bifidobacteria, preferably with a hydrophobicity of at least 80% H.

25. Composition according to claim 21 wherein the composition is a casein rich fraction wherein more than 80 wt % of the protein is casein.

26. Composition according to claim 21 wherein the composition is a serum protein rich fraction wherein more than 30 wt % of the protein is serum protein.

27. Composition according to claim 21 wherein the amount of beta-casein on total casein is at least 37%, preferably at least 39%, more preferably at least 41%.

28. Composition according to claim 21 wherein ratio of casein:serum protein is from 0.1 to 4.0, preferably 0.2-2.5, more preferably 0.3-1 most preferably 0.4-0.7

29. Composition according to claim 21 comprising fat wherein the fat comprises at least 25 wt % of butteroil.

30. Composition according to claim 21 wherein the food composition is selected from the group consisting of infant formula, medicinal food, neutraceutical food composition, yoghurt, drink, spread or cream.

31. Use of a casein rich fraction as claimed in claim 25 to produce a food composition, preferably an infant formula.

32. Use of a serum rich fraction as claimed in claim 26 and a milk wherein at least 98% of the gram negative bacteria are removed and which has been subjected to a heat treatment at a temperature between 60 and 90° C. and/or a milk protein concentrate wherein at least 98% of the gram negative bacteria are removed and which has been subjected to a heat treatment between temperature 60-90° C., to produce a food composition, preferably an infant formula.

33. Composition according to claim 21 wherein the amount of LPS is measured according to a LAL assay or a kinetic chromogenic LAL assay, preferably in the presence of a detergent.
